(19) United States
(12) Patent Application Publication
(10) Pub. No.: US 2009/0000604 A1
(43) Pub. Date: Jan. 1, 2009

(54) Engine system having aftertreatment and an intake air heater

(75) Inventors: Michael S. Bond, Chillicothe, IL (US); George E. Donaldson, Chillicothe, IL (US); David J. Kapparos, Chillicothe, IL (US); David A. Pierpont, Dunlap, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 11/819,880

(22) Filed: Jun. 29, 2007

(51) Int. Cl. F02G 5/00

(52) U.S. Cl. 123/548; 123/434; 123/435; 123/543; 123/549; 123/550; 123/552; 123/556

(57) ABSTRACT

An engine system for a power unit is disclosed. The engine system includes an exhaust system having at least one exhaust treatment device and an air induction system having at least one heater. The heater is configured to raise the temperature of an intake flow in the air induction system in response to a physical property of the exhaust treatment device.

### TECHNICAL FIELD

The present disclosure is directed to an engine system with exhaust aftertreatment and, more particularly, to a system having an inlet heater configured to heat the intake air of a combustion engine.

### BACKGROUND

Internal combustion engines, including diesel engines, gasoline engines, gaseous fuel powered engines, and other engines known in the art exhaust a complex mixture of air pollutants. These air pollutants may be composed of gaseous compounds, such as nitrogen oxides and carbon monoxide, and solid particulate matter, which may include unburned carbon particles also known as soot. Due to increased awareness of the environment, exhaust emission standards have become more stringent, and the amount of gaseous compounds and particulate matter emitted from an engine is regulated depending on the type of engine, size of engine, and/or class of engine.

One method implemented by engine manufacturers to comply with the regulation of emissions has been to remove the gaseous compounds and particulate matter from the exhaust flow of an engine using an exhaust aftertreatment device. An exhaust aftertreatment device can include a filter medium designed to trap particulate matter, and/or a catalyst utilized to absorb or convert nitrogen oxides and/or carbon monoxide to inert fluids.

Although effective, both a particulate trap and a catalyst may only operate properly when exposed to predetermined high temperatures. Specifically, a particulate trap requires periodic regeneration (i.e., the removal of collected particulate matter through exposure to temperatures above a combustion threshold of the matter). Similarly, a catalyst may only facilitate the necessary chemical reductions when exposed to sufficiently high temperatures.

One way to elevate the temperature of the particulate matter and/or the catalyst is to inject fuel into the exhaust flow of the engine and ignite the injected fuel with a burner. Although successful in some situations, this method can also be undesirable. For example, an exhaust burner may be associated with certain packaging characteristics and expenses. Specifically, locating fuel injection devices in an exhaust flow can result in their becoming dirty and being exposed to high temperatures that coke fuel in the burner. Thus, it may be desirable to dispose such burners elsewhere in relation to the engine.

An example of a burner located in the intake air flow of an engine is described in U.S. Pat. No. 3,977,376 (“the '376 patent”) issued to Reid et al. on Aug. 31, 1976. Specifically, the '376 patent teaches an engine system having a fuel-fired burner positioned in the engine intake manifold to increase the intake air temperature in a relationship that is linear to engine RPM. For example, engine control inputs are provided to initiate or terminate fuel flow to the burner in response to selected engine parameters (e.g., engine speed or water temperature), in order to promote intake air temperatures sufficient for efficient combustion, even at engine start-up and/or cold operating conditions.

Although the intake burner of the '376 patent may suffer less from fuel coking because of its location, its use may be limited. Specifically, the intake burner is only operated in relation to the engine conditions (i.e., in response to engine speed or water temperature). Thus, when the engine is operating at slower speeds, the burner may be inactive. In the case of a filter regeneration device, this speed limitation may prohibit regeneration at certain engine speeds, and the temperature attained by the burner of the '376 patent, although suitable for warming an engine, may be insufficient to regenerate a particulate trap or sufficiently heat a catalyst.

The engine system of the present disclosure solves one or more of the problems set forth above.

### SUMMARY OF THE DISCLOSURE

One aspect of the present disclosure is directed to an engine system for a power unit. The engine system may include an exhaust system having at least one exhaust treatment device, and an air induction system having at least one heater. The heater is configured to raise the temperature of an intake flow in the air induction system in response to a physical property of the exhaust treatment device.

Another aspect of the present disclosure is directed to a method of heating an exhaust treatment device that receives an exhaust flow from a power unit. The method may include determining a physical property of the exhaust treatment device. The method may also include raising the temperature of an air flow entering the power unit in response to the physical property determination.

### BRIEF DESCRIPTION OF THE DRAWINGS

FIG. 1 is a schematic and diagrammatic illustration of an exemplary disclosed power unit and treatment system.

### DETAILED DESCRIPTION

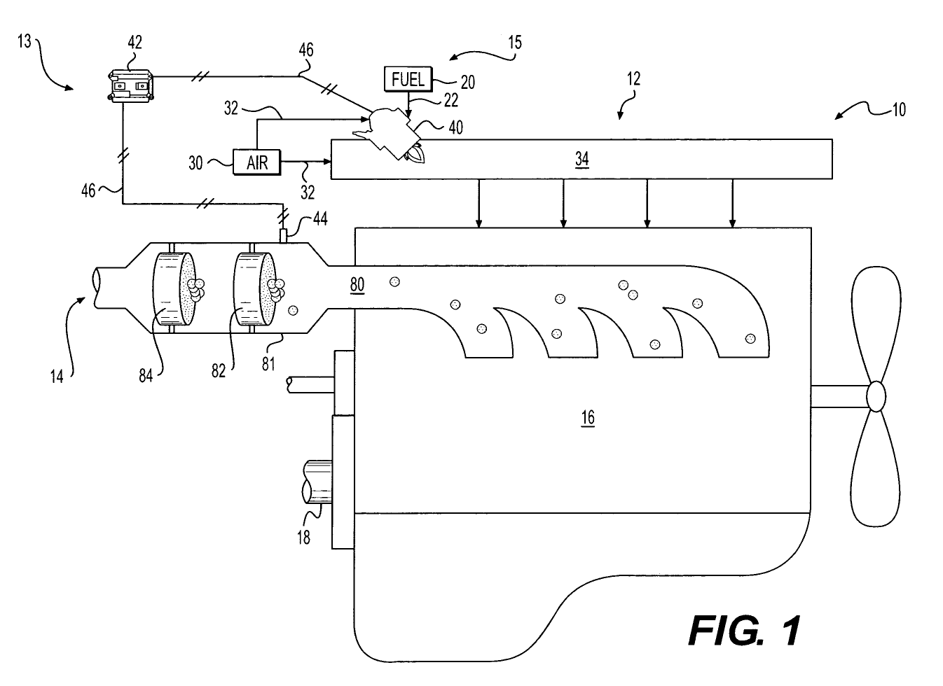

FIG. 1 illustrates a power unit 10 having an intake system 12 and an exhaust system 14. In one embodiment, power unit 10 may be associated with a mobile vehicle such as a passenger vehicle, a vocational vehicle, a farming vehicle or a construction vehicle. Alternatively, power unit 10 may be associated with a stationary machine such as an industrial power generator or a furnace.

For the purposes of this disclosure, power unit 10 is depicted and described as a four-stroke diesel engine. One skilled in the art will recognize, however, that power unit 10 may be any other type of internal combustion engine such as, for example, a gasoline or a gaseous fuel-powered engine. Power unit 10 may include an engine block 16 that at least partially defines a plurality of combustion chambers (not shown). In the illustrated embodiment, power unit 10 includes four combustion chambers. However, it is contemplated that power unit 10 may include a greater or lesser number of combustion chambers and that the combustion chambers may be disposed in an “in-line” configuration, a “V” configuration, or any other suitable configuration.

As also shown in FIG. 1, power unit 10 may include a crankshaft 18 that is rotatably disposed within engine block 16. A connecting rod (not shown) may connect a plurality of pistons (not shown) to crankshaft 18 so that a sliding motion of each piston within the respective combustion chamber results in a rotation of crankshaft 18. Similarly, a rotation of crankshaft 18 may result in a sliding motion of the pistons. Rotation of crankshaft 18 may function as output from power unit 10 for effecting a desired work such as rotation of a generator or rotation of one or more drive axles of an associated vehicle.

Intake system 12 may include an intake manifold 34 configured to provide a supply of air drawn into engine block 16 by the motion of the pistons described above. As illustrated, intake system 12 may further include an air supply 30 in communication with intake manifold 34 by a fluid line 32. Air supply 30 may include a compressor, a storage tank, and/or a duct for providing a supply of air to intake system 12 from an external or offboard source. Accordingly, intake manifold 34 of intake system 12 may provide compressed air for combustion in the combustion chambers of power unit 10. It is contemplated that power unit 10 may alternatively be naturally aspirated, if desired.

Exhaust system 14 may include an exhaust manifold 80 configured to expel exhaust generated by power unit 10 toward a housing 81 located downstream from exhaust manifold 80. Housing 81 of exhaust system 14 may be a cylindrical or tubular conduit for directing exhaust gasses and particulates away from power unit 10 for processing by various emission controlling devices. That is, housing 81 may constitute structural support for at least one exhaust treatment device. In the embodiment of FIG. 1, a first exhaust treatment device 82 and a second exhaust treatment device 84 are illustrated. However, it is contemplated that exhaust system 14 may include any number of devices and other fluid handling components such as, for example, a turbine, an exhaust gas recirculation system, an attenuation device, or any other exhaust system component known in the art.

First and second exhaust treatment devices 82, 84 may be disposed across the cylindrical width (i.e., cross section) of housing 81 and either removably or fixedly secured at their perimeter to housing 81. First and second exhaust treatment devices 82, 84 may be any variety of diesel particulate filter (“DPF”) such as, for example, a corderite or silicon carbide wall-flow filter, a metal fiber flow-through filter, or a partial flow filter. First and second exhaust treatment devices 82, 84 may also include any variety of NOx aftertreatment such as a Selective Catalytic Reduction (SCR) device configured to reduce an exhaust constituent and receive an injection of a reductant, such as ammonia, AdBlue, and/or urea, if desired. First and second exhaust treatment devices 82, 84 may also include a Lean NOx Trap. In one embodiment, first exhaust treatment device 82 may be a particulate trap, whereas second exhaust treatment device 84 may be a selective catalytic reduction device.

As exhaust from power unit 10 flows through first and second exhaust treatment devices 82, 84, exhaust constituents such as particulate matter and nitrogen oxides (NOx) may be removed from the exhaust flow. Over time, the particulate matter may build up in first exhaust treatment device 82 and, if left unchecked, the particulate matter buildup could be significant enough to restrict or even block the flow of exhaust through first and second exhaust treatment devices 82, 84, allowing backpressure within the power unit 10 to increase. An increase in the backpressure of power unit 10 could reduce the power unit's ability to draw in fresh air, resulting in decreased performance, increased exhaust temperatures, and poor fuel consumption.

Accordingly, there is a need to regenerate or otherwise heat exhaust treatment devices 82, 84 to clear them of particulates and other contaminants and/or to improve their constituent reducing effectiveness. This may be done by raising the temperature of the exhaust passing through exhaust treatment devices 82, 84 to a combustion threshold of the trapped particulates, such that the matter oxidizes and burns away from the device, or to a level that otherwise supports efficient reduction of the exhaust constituents. To facilitate this temperature rise, a treatment system 13 may be associated with intake system 12 and exhaust system 14. Treatment system 13 may include a heater 40, a controller 42, and a sensor 44.

Heater 40 may include any device configured to heat a gaseous flow, such as a fuel powered burner or an electrical resistance heater. Heater 40 may be disposed in fluid communication with an air flow of intake system 12. For example, as illustrated in FIG. 1, heater 40 may be disposed in direct communication with intake manifold 34. Alternatively, heater 40 may be disposed anywhere between air supply 30 and intake manifold 34.

In the event that heater 40 includes a fuel powered burner, as illustrated in FIG. 1, heater 40 may be configured to create a fuel/air mixture for combustion purposes. Specifically, compressed air may be mixed with injections of fuel from a high pressure source and ignited to create a combustion source within intake system 12. For example, heater 40 may be provided with compressed air from an air supply 30 via fluid line 32, and provided with pressurized fuel from a fuel system 15. Heater 40 may receive pressurized fuel from a fuel supply 20 via a fluid line 22. Accordingly, heater 40 may be configured to raise the temperature of an intake air flow by combusting the mixture at a location within or proximate intake manifold 34.

Sensor 44 may be any type of sensor configured to detect and measure a physical or chemical property of exhaust flow through housing 81. For example, sensor 44 may include a temperature sensing device such as a surface-type temperature sensing device that measures a wall temperature of housing 81 or a temperature of one or both of first and second exhaust treatment devices 82, 84. Alternately, sensor 44 may include a gas-type temperature sensing device that directly measures the temperature of the exhaust gas proximate one or both of first and second exhaust treatment devices 82, 84. Upon measuring the temperature of the exhaust gas, sensor 44 may generate an exhaust gas temperature signal and send this signal to controller 42 via a communication line 46, as is known in the art. This temperature signal may be sent continuously, on a periodic basis, or only when prompted to do so by controller 42, if desired.

Sensor 44 may alternatively or additionally embody a pressure sensing device such as a differential pressure sensor or gage pressure sensor. For example, sensor 44 may include a pressure transducer configured to generate an analog signal indicative of the exhaust pressure proximate (upstream or downstream) one of first and second exhaust treatment devices 82, 84. In another example, sensor 44 may be configured to measure a pressure both upstream and downstream of exhaust treatment device 82 and/or 84 to enable a pressure differential measurement across the respective device. Upon measuring a pressure of the exhaust gas, sensor 44 may generate an exhaust gas pressure signal and send this signal to controller 42 via a communication line 46, as is known in the art. This pressure signal may be sent with or independent of the above-mentioned temperature signal. Furthermore, the pressure signal may be sent continuously, on a periodic basis, or only when prompted to do so by controller 42.

Controller 42 may include one or more microprocessors, a memory, a data storage device, a communication hub, and/or other components known in the art and may be associated only with treatment system 13. However, it is contemplated that controller 42 may be integrated within a general control system capable of controlling additional functions of power unit 10, e.g., selective control of intake system 12, exhaust system 14, fuel system 15, and/or additional systems operatively associated with power unit 10, e.g., selective control of an engine or a transmission system (not shown).

Controller 42 may be in communication with both heater 40 and sensor 44 via communication lines 46. Specifically, controller 42 may receive signals from sensor 44 and analyze the data to determine whether the temperature or pressure of the exhaust gas and/or proximate exhaust treatment devices is within a desired range by comparing the data to threshold values stored in or accessible by controller 42. Controller 42 may be configured to control the operation of heater 40 based on inputs received from sensors 44. Specifically, upon receiving input signals from sensor 44, controller 42 may perform a plurality of operations, e.g., algorithms, equations, subroutines, and/or reference look-up maps or tables to establish an output to influence the operation of heater 40 and/or sensor 44. Alternatively, it is contemplated that controller 42 may receive signals from various sensors (not shown) located throughout power system 10 in addition to sensor 44. Such sensors may sense parameters that may be used to calculate or approximate the temperature and/or pressure of exhaust gas flowing through housing 81.

### INDUSTRIAL APPLICABILITY

The exhaust heating device and methods of the present disclosure may be applicable to a variety of aftertreatment systems requiring selectively elevated temperatures for efficient operation. For example, the disclosed regeneration device may elevate temperatures in an aftertreatment device of a power unit by raising the temperature of an engine intake air flow such that the temperature of exhaust flow is also raised. By raising the temperature of exhaust flow, via heating of the intake flow, the aftertreatment device may be actively regenerated and/or the operation thereof improved, without subjecting the heating device to the damaging environment of the exhaust flow. The operation of power unit 10 will now be explained.

Referring to FIG. 1, air and fuel may be drawn into combustion chambers (not shown) of power unit 10 for subsequent combustion. Specifically, fuel from fuel system 15 may be injected into combustion chambers of power unit 10, mixed with the air therein, and combusted to produce a mechanical work output and an exhaust flow of hot gases. The exhaust flow may contain a complex mixture of air pollutants composed of gaseous and solid material, which can include particulate matter. As this particulate laden exhaust flow is directed from power unit 10 through exhaust manifold 80, exhaust constituents such as particulate matter and/or gaseous contaminants may be removed or reduced from the exhaust flow by first and second exhaust treatment devices 82, 84.

Over time, the efficiency of first and second exhaust treatment devices 82, 84 may decrease. For example, particulate matter may build up in at least one of first and second exhaust treatment devices 82, 84 and, if left unchecked, the buildup could be significant enough to restrict, or even block the flow of exhaust. As indicated above, the restriction of exhaust flow from power unit 10 may increase the backpressure of power unit 10 and reduce the unit's ability to draw in fresh air, resulting in decreased performance of power unit 10, increased exhaust temperatures, and poor fuel consumption. Alternatively, in the event that one of first and second exhaust treatment devices 82, 84 is an SCR device, exhaust temperatures may be insufficient for the efficient reduction of one or more gaseous exhaust constituents.

Therefore, first and second exhaust treatment devices 82, 84 may be treated to prevent an undesired reduction in their efficiency or operation altogether. For this purpose, treatment system 13 may heat the intake air flow to power unit 10 such that the exhaust flow passing through first and second exhaust treatment devices 82, 84 is hot enough to promote efficient operation. Treatment system 13 may heat intake flow according to any desired initiation and duration methods, as described below.

Sensor 44 may detect a physical property within exhaust flow in exhaust system 14. Alternatively sensor 44 may detect a property of one or both of first and second exhaust treatment devices 82, 84. In the event that sensor 44 is replaced or supplemented with several sensors disposed at varying locations of the system, sensors 44 may detect a plurality of data points for consideration by treatment system 13. Sensor 44 may convert and transmit one or more signals corresponding to the property to controller 42.

Controller 42 may receive the signal from sensor 44 and perform a plurality of operations, e.g., algorithms, equations, subroutines, reference look-up maps or tables to establish an output to influence the operation of heater 40 and/or sensor 44. For example, operation of heater 40 may be controlled in a manner that is periodic or based on a triggering condition such as, for example, an elapsed time of engine operation, a discrete pressure measurement at any location of the intake or exhaust flow, a pressure differential measured across one or both of first and second exhaust treatment devices 82, 84, a temperature of the exhaust flow out of power unit 10, or any other condition known in the art. Heating may also be controlled in terms of timing and temperature, depending on the particular needs of treatment devices such as DPF's and/or SCR's (or LNT's), as they happen to be incorporated. For example, the temperature may be raised to a level required for particulate regeneration. In one embodiment, effective operation of an exhaust treatment device may require raising exhaust flow temperatures to at least 300° C. Depending on the logic of controller 42, controller 42 may instruct the initiation of, and control the extent and duration of, a heating event performed by heater 40.

In the event that heater 40 is a fuel powered burner, fuel system 15 may pressurize fuel from a low pressure fuel pump (i.e., “transfer pump”) of the engine and provide it to heater 40 via fuel line 22. Intake system 12 may provide a supply of compressed air to heater 40 via fluid line 32. Heater 40 may therefore generate a fuel/air mixture for combustion in, or proximate to, intake manifold 34. Specifically, the fuel/air mixture may be selectively injected into a combustion canister and ignited at a desired time, as instructed by controller 42. The ignited flow of fuel and air may raise the temperature of the intake air flow entering power unit 10 and thereby raise the temperature of exhaust flow exiting power unit 10. In the event that heater 40 is an electrical resistance heater, a resistive element therein may raise the temperature of an intake flow with which it is in fluid communication. Controller 42 may thereby instruct heater 40 to treat first and second exhaust treatment devices 82, 84 by heating intake air according to data parameters detected by and transmitted from sensors 44.

Because exhaust flow temperatures may be raised by burner 40, particulate matter trapped within first exhaust treatment device 82 may be raised to a temperature above the combustion threshold of the entrapped particulate matter, thereby burning away the particulate matter and regenerating at least one of the first and second exhaust treatment devices 82, 84. Alternatively, or additionally, gaseous exhaust constituents passing through a selective catalytic reduction or Lean NOx Trap device may be effectively reduced, due to increased exhaust flow temperatures.

Because the presently disclosed heating device may operate in the intake air flow of an engine, the system may be reliable and may ensure continued and successful regeneration events in an efficient manner with components having a prolonged useful life. Specifically, heater 40 may be spared from the harmful effects of exhaust flow, such as high temperatures and contaminant concentration. Accordingly, maintenance, and replacement costs of the present system are reduced.

It will be apparent to those skilled in the art that various modifications and variations can be made to the aftertreatment system of the present disclosure without departing from the scope of the disclosure. Other embodiments will be apparent to those skilled in the art from consideration of the specification and practice of the aftertreatment system and methods disclosed herein. It is intended that the specification and examples be considered as exemplary only, with a true scope of the disclosure being indicated by the following claims and their equivalents.

What is claimed is:

1. An engine system for a power unit, comprising:
an exhaust system having at least one exhaust treatment device; and
an air induction system having at least one heater;
wherein the heater is configured to raise the temperature of an intake flow in the air induction system in response to a physical property of the exhaust treatment device.

2. The engine system of claim 1, further including a sensor disposed in the exhaust system and configured to generate a signal indicative of a physical property proximate the at least one exhaust treatment device.

3. The engine system of claim 2, wherein the sensor is a pressure transducer.

4. The engine system of claim 2, wherein the sensor is a thermocouple.

5. The engine system of claim 2, further including a controller disposed in communication with the sensor and the heater.

6. The engine system of claim 5, wherein the controller is configured to compare the physical property to a threshold value and actuate the heater in response to the comparison.

7. The engine system of claim 1, wherein the heater is a fuel powered burner.

8. The engine system of claim 1, wherein the heater is an electrical resistance heater.

9. The engine system of claim 1, wherein the exhaust treatment device is a particulate trap, and the heater is configured to raise the temperature of the exhaust passing through the particulate trap to a level that combusts particulate matter collected in the particulate trap.

10. The engine system of claim 1, wherein the exhaust treatment device is a selective catalytic reduction device, and the heater is configured to raise the temperature of the exhaust passing through the selective catalytic reduction device to a level that reduces at least 50% of an exhaust constituent.

11. A method of heating an exhaust treatment device that receives an exhaust flow from a power unit, comprising:
determining a physical property of the exhaust treatment device; and
raising the temperature of an air flow entering the power unit in response to the physical property determination.

12. The method of claim 11, wherein the physical property is determined by measuring the temperature of the exhaust flow.

13. The method of claim 11, wherein the physical property is determined by measuring the temperature of the exhaust treatment device.

14. The method of claim 11, wherein the physical property is determined by measuring the pressure of the exhaust flow upstream of the exhaust treatment device.

15. The method of claim 11, wherein the physical property is determined by measuring a pressure drop across the exhaust treatment device.

16. The method of claim 11, wherein the temperature of the air flow is raised to a level that combusts particulate matter in the exhaust treatment device.

17. The method of claim 11, wherein the temperature of the air flow is raised to a level that reduces at least 50% of an exhaust constituent.

18. The method of claim 11, wherein the temperature of the intake flow is raised to at least 300° C.

19. A power system, comprising:
a combustion engine configured to produce a power output and an exhaust flow;
an exhaust system having at least one exhaust treatment device configured to remove particulates from the exhaust flow; and
an air induction system having at least one heater;
wherein the heater is configured to raise the temperature of an intake flow in the air induction system in response to a physical property of the exhaust treatment device.

20. The power system of claim 19, wherein the exhaust treatment device is a diesel particulate trap and the heater is a fuel powered burner.
